(19) United States
(12) Patent Application Publication
(10) Pub. No.: US 2016/0249639 A1
(43) Pub. Date: Sep. 1, 2016

(54) IMPROVED PELLETS CONTAINING VITAL GLUTEN AND PROCESS FOR THEIR PRODUCTION

(71) Applicant: SÜDZUCKER AKTIENGESELLSCHAFT MANNHEIM/OCHSENFURT, Mannheim (DE)

(72) Inventors: Hans-Jörg Menger, Reilingen (DE); Ralf Möller, Vinalmont (BE)

(73) Assignee: Südzucker Aktiengesellschaft Mannheim/Ochsenfurt, Mannheim (DE)

(21) Appl. No.: 15/033,710

(22) PCT Filed: Oct. 31, 2014
(86) PCT No.: PCT/EP2014/073437

§ 371 Date: May 2, 2016

(30) Foreign Application Priority Data
Oct. 31, 2013 (EP) 13191081.2

(51) Int. Cl. A23J 3/18; A23K 40/10; A23N 17/00; A23K 10/38

(52) U.S. Cl. CPC A23J 3/18; A23K 10/38; A23K 40/10; A23L 1/0023; A23L 1/10; A23N 17/005; A23P 1/025; A23V 2002/00

(57) ABSTRACT

The present invention relates to a process for preparing pellets of compressed proteins comprising vital gluten, pellets obtainable by such a process and an apparatus used in such a process.

### TECHNICAL FIELD

The present invention relates to a process for preparing pellets of compressed proteins comprising vital gluten, pellets obtainable by such a process and an apparatus used in such a process.

### BACKGROUND OF THE INVENTION

Gluten is a protein composite known to the skilled person. Gluten is mostly derived from wheat and related grain species, including barley and rye. Gluten is a composite of gliadin and glutenin, which is conjoined with starch in the endosperm of various grass-related grains. The gliadin and glutenin from wheat constitute about 80% of the protein contained in wheat fruit. Gliadin is alcohol-soluble and glutenin is soluble in dilute acid or alkali. Being insoluble in water, they can be purified by washing away associated starch. Worldwide, gluten is a source of protein, both in foods prepared directly from sources containing it and as an additive to foods or animal feed.

Gluten is a typical by-product in the production process of ethanol from crops like wheat.

Often the proteins comprising vital gluten are stored and are available in a dried powder form. This dried powder is difficult to handle.

For better handling there are also protein pellets containing gluten. WO 98/49904 relates to the formation of porous feed pellets by extrusion, drying and absorbing oil into said pellets by vacuum coating which is complex and expensive. An alternative method is described in WO 97/22265 A1 and suggests coating extrusion form pellets with water soluble starches which is also complex and expensive. EP 0838159 A1 describes a method for the size reduction of wheat gluten. The granules are stored at temperatures below 0° C. which is also complex and expensive. U.S. Pat. No. 6,309,680 B1 relates to a pelletisation process wherein the wheat gluten is denaturated. Therefore, these pellets contain vital gluten in only low amounts.

EP 1785039 A1 describes a process for preparing pellets consisting of dry compressed proteins comprising gluten and having a moisture content of maximum 12 weight-%. The method uses heated air or steam and temperatures from at least 50° C. up to 90° C. also during mixing. Moisture is added in this process in an amount of at most 5 weight-%, preferably only up to 3 weight-%. The use of hot air or steam is expensive and results in high temperatures, especially over a long period, and accordingly in low amounts of vital gluten.

### SUMMARY OF THE INVENTION

The technical problem underlying the present invention is to provide a cheaper and better method to produce pellets containing vital gluten than the methods described in the state of the art. A further problem underlying the present invention is to provide a method for the production of pellets resulting in pellets with a high content of vital gluten. A further problem underlying the present invention is to provide a method for the cost-efficient use of the by-products in ethanol production processes. A further problem underlying the present invention is the provision of pellets comprising gluten, wherein a high amount of the gluten is vital.

The present invention solves the underlying technical problem by the provision of the subject matter of the independent claims. The present invention solves the underlying technical problem especially by the provision of a process according to claim 1.

The present invention solves the underlying technical problem especially by the provision of a process for preparing at least one pellet of compressed proteins comprising vital gluten, the process comprising following steps: a) providing proteins comprising vital gluten, b) mixing the proteins comprising vital gluten with an humectant to form a mixture, wherein the humectant comprises a liquid compound, and c) forming at least one pellet from the mixture of the proteins comprising vital gluten and the humectant.

The present invention solves the underlying technical problem preferably also by the provision of a process for preparing at least one pellet of compressed proteins comprising vital gluten, the process comprising following steps: a) providing proteins comprising vital gluten, b) mixing the proteins comprising vital gluten with an humectant, wherein the humectant comprises a liquid compound to form a mixture, c) forming at least one pellet from the mixture of the proteins comprising vital gluten and the humectant, and d) feeding the at least one pellet obtained in step c) into a repository via a pneumatic transport device.

The present invention solves the underlying technical problem preferably also by the provision of a process for preparing at least one pellet of compressed proteins comprising vital gluten, the process comprising following steps: a) providing proteins comprising vital gluten, b) mixing the proteins comprising vital gluten with an humectant, wherein the humectant consists of an liquid compound to form a mixture, wherein the liquid compound has a total content of solid matter of at most 15 weight-%, wherein the temperature of the mixture is at least 34° C. and at most 45° C., and c) forming at least one pellet from the mixture of the proteins comprising vital gluten and the humectant.

The present invention solves the underlying technical problem preferably also by the provision of a process for preparing at least one pellet of compressed proteins comprising vital gluten, the process comprising following steps: a) providing proteins comprising vital gluten, b) mixing the proteins comprising vital gluten with an humectant, wherein the humectant consists of an liquid compound to form a mixture, wherein the liquid compound has a total content of solid matter of at most 15 weight-%, wherein the temperature of the mixture is at least 34° C. and at most 45° C., c) forming at least one pellet from the mixture of the proteins comprising vital gluten and the humectant and d) feeding the at least one pellet obtained in step c) into a repository via a pneumatic transport device.

The inventors of the present invention found that surprisingly at least parts of the steam or even most or all of the steam used to moisten protein compositions comprising gluten can be replaced by a liquid compound, for example an aqueous system like water or stillage. Furthermore, the inventors found that surprisingly the mixing step, wherein the proteins comprising gluten are moistened, can be done at lower temperatures than in the state of the art. This finding has several advantages. On one hand, there is no need to use hot air and the use of steam can be at least reduced. This saves energy and accordingly costs. On the other hand, the proteins and especially the gluten is exposed to high temperatures only during a short period, i.e. during and shortly after the forming step of the pellets or is even not exposed to higher temperatures at all if a low mixing temperature is chosen. This results advantageously in a high content of vital gluten in the pellets. Accordingly, there are provided also pellets of compressed proteins comprising gluten, wherein the gluten has a high vitality.

### DETAILED DESCRIPTION OF CERTAIN EMBODIMENTS OF THE INVENTION

In the context of the present invention the term “comprising” preferably has the meaning of “containing” or “including” meaning that the formulation in question at least comprises the specifically identified component without excluding the presence of further components. However, in a preferred embodiment the term comprising is also understood to have the meaning of “consisting essentially of” and in a most preferred embodiment of “consisting”. The term “consisting essentially of” excludes the presence of substantial amounts of further components except the specifically identified component of the formulation. The term “consisting essentially of” excludes preferably the presence of amounts of more than 5 weight-%, even more preferably of more than 2 weight-%, most preferably of more than 1 weight-% of further components except the specifically identified component of the formulation. The term “consisting” excludes the presence of any further compound, no matter in which quantity in the formulation identified.

In the context of the present invention the term “comprising essentially” preferably has the meaning that the specifically identified component is the component with the highest proportion in the formulation in question compared to the components present in the formulation in question. However, in a preferred embodiment the term “comprising essentially” means that the formulation in question comprises at least 50 weight-%, even more preferably at least 51 weight-% of the specifically identified component.

If not outlined else, %-values given the in present description mean weight-%.

In the context of the present invention the term “at least one” preferably has the meaning that one component or more than one components, for example two, three or more components, for example a plurality of components, are present.

Of course, the method according to the present invention can also be used for preparing one pellet or at least one pellet or for preparing more than one pellet, especially a plurality of pellets.

According to the present invention, proteins comprising vital gluten are used. Preferably the proteins comprising vital gluten comprise at least 50 weight-% gluten. More preferably the proteins comprising vital gluten comprise at least 75 weight-% gluten. More preferably the proteins comprising vital gluten comprise at least 98 weight-% gluten. In a preferred embodiment of the present invention, the proteins comprising vital gluten consist essentially of gluten. In an alternative embodiment of the present invention the proteins comprising vital gluten consist of gluten.

Preferably protein particles are provided in step a).

Preferably the proteins comprising vital gluten are provided in step a) as powder or granulate. Preferably the proteins are provided in step a) as powder. Preferably the proteins are provided in step a) as milled meal or flour.

Preferably 20% of the protein powder, preferably protein meal, provided in step a) has a diameter of at most around 20 μm, especially of at most 20 μm. Preferably 50% of the protein powder, preferably protein meal, provided in step a) has a diameter of at most about 60 μm, more preferably of at most 60 μm. Preferably 90% of the protein powder, preferably protein meal, provided in step a) has a diameter of at most 500 μm, more preferably of at most 350 μm, most preferably of at most 250 μm.

Preferably 90% of the protein powder, preferably protein meal, provided in step a) has a diameter of at least 0.5 μm, more preferably of at least 1 μm, even more preferably of at least 3 μm, most preferably of at least 10 μm.

Preferably the proteins comprising vital gluten are a gluten powder, more preferably a gluten meal, most preferably a wheat gluten meal.

Preferably the proteins comprising vital gluten are derived from an ethanol production process.

Gluten is a protein found in many grains and cereals, for example wheat, corn, oats, rye and barley. The term “gluten” as used herein refers to gluten from any available source and to mixtures of gluten from different sources. Vital gluten, especially vital wheat gluten, has the ability to be very elastic when water is added.

Preferably the proteins comprising vital gluten are obtained from corn, wheat, rice, rye, oat, barley and sorghum. Preferably the proteins comprising vital gluten are derived from plants, more preferably from corn and/or grain, for example wheat, barley and/or rye, most preferably from wheat. Preferably the proteins comprising vital gluten are derived from wheat or corn or from mixtures thereof. Preferably the proteins comprising vital gluten are derived from wheat. In a preferred embodiment of the present invention the proteins comprising vital gluten consist essentially of wheat gluten.

In a preferred embodiment of the present invention at least 30 weight-% of the humectant consists of the liquid compound. In a preferred embodiment of the present invention at least 50 weight-% of the humectant consists of the liquid compound. In a more preferred embodiment of the present invention at least 75 weight-% of the humectant consists of the liquid compound. In an even more preferred embodiment of the present invention at least 85 weight-% of the humectant consists of the liquid compound. In a further preferred embodiment of the present invention at least 96 weight-% of the humectant consists of the liquid compound.

In a further preferred embodiment of the present invention at most 100 weight-% of the humectant consists of the liquid compound.

In a preferred embodiment of the present invention the humectant consists essentially of the liquid compound. In a preferred embodiment of the present invention the humectant consists of the liquid compound.

In a preferred embodiment of the present invention the liquid compound is an aqueous system or aqueous solution.

In a preferred embodiment of the present invention the humectant comprises an aqueous system. In a preferred embodiment of the present invention the humectant consists essentially of an aqueous system. In a preferred embodiment of the present invention the humectant is an aqueous system. In a preferred embodiment of the present invention the humectant is a liquid aqueous system.

Preferably the humectant, more preferably the liquid compound, even more preferably the aqueous system has a total content of solid matter of at most 15 weight-%. More preferably the humectant, more preferably the liquid compound, even more preferably the aqueous system has a total content of solid matter of at most 10 weight-%. More preferably the humectant, more preferably the liquid compound, even more preferably the aqueous system has a total content of solid matter of at most 7.5 weight-%. Even more preferably the humectant, more preferably the liquid compound, even more preferably the aqueous system has a total content of solid matter of at most 5 weight-%. Most preferably the humectant, more preferably the liquid compound, even more preferably the aqueous system has a total content of solid matter of at most 4 weight-%.

Preferably the humectant, more preferably the liquid compound, even more preferably the aqueous system has a total content of solid matter of at least 0 weight-%. Preferably the humectant, more preferably the liquid compound, even more preferably the aqueous system has a total content of solid matter of at least 0.5 weight-%. Preferably the humectant, more preferably the liquid compound, even more preferably the aqueous system has a total content of solid matter of at least 1 weight-%.

Preferably the humectant, more preferably the liquid compound, even more preferably the aqueous system has a total content of solid matter of at least 0 weight-% and at most 15 weight-%. Preferably the humectant, more preferably the liquid compound, even more preferably the aqueous system has a total content of solid matter of at least 0 weight-% and at most 10 weight-%. Preferably the humectant, more preferably the liquid compound, even more preferably the aqueous system has a total content of solid matter of at least 0 weight-% and at most 8 weight-%. Preferably the humectant, more preferably the liquid compound, even more preferably the aqueous system has a total content of solid matter of at least 0 weight-% and at most 5 weight-%.

A low solid matter content in the humectant has the advantage that the resulting pellet of compressed proteins has only minor impurities due to substances being present in the humectant, especially nonprotein substances like carbohydrate and ashes, but also protein substances beside gluten. Furthermore the humectant can be mixed with the proteins comprising vital gluten a higher amount.

In a preferred embodiment of the present invention the humectant comprises liquid water and/or stillage and/or process condensate. In a preferred embodiment of the present invention the humectant consists of liquid water and/or stillage and/or process condensate. In a preferred embodiment of the present invention the humectant consists of liquid water and stillage. In a preferred embodiment of the present invention the humectant consists of liquid water or stillage. In a preferred embodiment of the present invention the humectant consists of liquid water or process condensate. In a preferred embodiment of the present invention the humectant consists of liquid water and process condensate. In a preferred embodiment of the present invention the humectant consists of liquid water and stillage and process condensate.

In a preferred embodiment of the present invention the humectant has a content of solid matter of less than 20 weight-% and therefore is preferably no concentrated vinasse, no molasses, no corn syrup or no lignosulfonates.

In a preferred embodiment of the present invention the humectant comprises liquid water. In a preferred embodiment of the present invention the humectant consists essentially of liquid water. In a preferred embodiment of the present invention the humectant consists of liquid water.

In a preferred embodiment the liquid compound is water and/or stillage. In a preferred embodiment the liquid compound is water and stillage. In a preferred embodiment the liquid compound is water or stillage. In a preferred embodiment the liquid compound is water. In an alternative embodiment the liquid compound is stillage.

In an alternative embodiment the liquid compound is water and/or process condensate. In a preferred embodiment the liquid compound is water and process condensate. In a preferred embodiment the liquid compound is water or process condensate. In an alternative embodiment the liquid compound is process condensate.

In a preferred embodiment of the present invention the humectant comprises stillage. In a preferred embodiment of the present invention the humectant consists essentially of stillage. In a preferred embodiment of the present invention the humectant consists of stillage.

In the context of the present invention “stillage”, also known to the skilled person as distillery wastewater, distillery pot ale, distillery slops, distillery spent wash, dunder and mosto is preferably the aqueous by-product from a distillation, preferably the distillation of ethanol following fermentation of carbohydrates. The stillage contains non-fermentable solids and water. The production of ethanol from biomass, whether from sugar crops, starch crops, dairy products or cellulosic materials results in the concurrent production of stillage which exhibits a considerable pollution potential.

The inventors of the present invention found surprisingly that the stillage obtained in the ethanol production as by-product can be used as humectant in the production process of pellets containing protein comprising gluten. Accordingly, the method according to the present invention can use two of the typical by-products in the ethanol production, i.e. proteins comprising gluten or gluten itself and stillage. Therefore, the method according to the present invention provides the possibility to use the by-products of ethanol production in an effective way.

Preferably the stillage is derived from a distillation process. More preferably the stillage is derived from a distillation step in the production-process of ethanol.

“Stillage” in the context of the present invention refers to the stillage directly obtained from a distillation step but also to thin stillage.

Preferably the stillage is a thin stillage. Thin stillage is known to the skilled person and is derived from stillage by separation of at least parts of the non-fermentable solids out of the water.

Preferably the stillage has a total content of solid matter of at most 15 weight-%. Preferably the stillage has a total content of solid matter of at most 12 weight-%. More preferably the stillage has a total content of solid matter of at most 10 weight-%. More preferably the stillage, especially the thin stillage, has total content of solid matter of at most 7.5 weight-%. Even more preferably the stillage, especially the thin stillage, has a total content of solid matter of at most 5 weight-%. Most preferably the stillage, especially the thin stillage has a total content of solid matter of at most 4 weight-%.

Preferably the stillage, especially the thin stillage has a total content of solid matter of at least 0 weight-%. Preferably the stillage, especially the thin stillage has a total content of solid matter of at least 0.5 weight-%. Preferably the stillage, especially the thin stillage has a total content of solid matter of at least 1 weight-%.

Preferably the stillage, especially the thin stillage has a total content of solid matter of at least 0 weight-% and at most 15 weight-%. Preferably the stillage, especially the thin stillage has a total content of solid matter of at least 0 weight-% and at most 10 weight-%. Preferably the stillage, especially the thin stillage has a total content of solid matter of at least 0 weight-% and at most 8 weight-%. Preferably the stillage, especially the thin stillage has a total content of solid matter of at least 0 weight-% and at most 5 weight-%.

In a preferred embodiment of the present invention the humectant comprises process condensate. In a preferred embodiment of the present invention the humectant consists essentially of process condensate. In an alternative embodiment of the present invention the humectant consists of process condensate.

The inventors of the present invention found surprisingly that also a process condensate, especially the process condensate obtained in the ethanol production as by-product can be used as humectant in the production process of pellets containing protein comprising gluten. Accordingly, the method according to the present invention can use a further by-product in the ethanol production, i.e. process condensate.

Preferably the process condensate has a total content of solid matter of at most 15 weight-%. Preferably the process condensate has a total content of solid matter of at most 12 weight-%. More preferably the process condensate has a total content of solid matter of at most 10 weight-%. More preferably the process condensate has total content of solid matter of at most 7.5 weight-%. Even more preferably the process condensate has a total content of solid matter of at most 5 weight-%. Most preferably the process condensate has a total content of solid matter of at most 4 weight-%.

Preferably the process condensate has a total content of solid matter of at least 0 weight-%. Preferably the process condensate has a total content of solid matter of at least 0.5 weight-%. Preferably the process condensate has a total content of solid matter of at least 1 weight-%.

Preferably the process condensate has a total content of solid matter of at least 0 weight-% and at most 15 weight-%. Preferably the process condensate has a total content of solid matter of at least 0 weight-% and at most 10 weight-%. Preferably the process condensate has a total content of solid matter of at least 0 weight-% and at most 8 weight-%. Preferably the process condensate has a total content of solid matter of at least 0 weight-% and at most 5 weight-%.

In a preferred embodiment of the present invention the humectant comprises essentially no steam. In a preferred embodiment of the present invention the humectant comprises no steam.

In a preferred embodiment of the present invention essentially no steam is added in step b). In a preferred embodiment of the present invention no steam is added in step b).

In a preferred embodiment of the present invention essentially no heated air is added in step b). In a preferred embodiment of the present invention no heated air is added in step b).

In an alternative embodiment the humectant can comprise steam additionally to the liquid compound. This means that the humectant comprises a liquid compound and steam, i.e. that at least parts of the steam used in the state of the art are exchanged by the liquid compound.

Preferably the humectant comprises steam in an amount so that the steam adds in step b) moisture in an amount of at most 3 weight-% of the total weight of the obtained mixture, more preferably of at most 2.9 weight-% of the total weight of the obtained mixture, even more preferably of at most 2.5 weight-% of the total weight of the obtained mixture, most preferably of at most 2 weight-% of the total weight of the obtained mixture.

Preferably the humectant comprises steam in an amount so that the steam adds in step b) moisture in an amount of 0 to 3 weight-% of the total weight of the obtained mixture, more preferably of 0 to 2.9 weight-% of the total weight of the obtained mixture, even more preferably of 0 to 2.5 weight-% of the total weight of the obtained mixture, most preferably of 0 to 2 weight-% of the total weight of the obtained mixture.

In a further preferred embodiment at least 50 weight-% of the moisture added from the humectant to the proteins comprising vital gluten in step b) are from the liquid compound and at most 50 weight-% of the moisture added from the humectant to the proteins comprising vital gluten in step b) are from steam. In a further preferred embodiment at least 67 weight-% of the moisture added from the humectant to the proteins comprising vital gluten in step b) are from the liquid compound and at most 33 weight-% of the moisture added from the humectant to the proteins comprising vital gluten in step b) are from steam. In a further preferred embodiment at least 75 weight-% of the moisture added from the humectant to the proteins comprising vital gluten in step b) are from the liquid compound and at most 25 weight-% of the moisture added from the humectant to the proteins comprising vital gluten in step b) are from steam.

In a further preferred embodiment at most 100 weight-% of the moisture added from the humectant to the proteins comprising vital gluten in step b) are from the liquid compound and at least 0 weight-% of the moisture added from the humectant to the proteins comprising vital gluten in step b) are from steam. In a further preferred embodiment at most 98 weight-% of the moisture added from the humectant to the proteins comprising vital gluten in step b) are from the liquid compound and at least 2 weight-% of the moisture added from the humectant to the proteins comprising vital gluten in step b) are from steam.

In a further preferred embodiment steam is present in the humectant in an amount so that the temperature of the mixture obtained in step b) is at most 30° C. higher, more preferably at most 20° C. higher, even more preferably at most 15° C. higher than the temperature of the proteins comprising vital gluten provided in step a), i.e. the temperature at the beginning of step b).

In a further preferred embodiment steam is present in the humectant in an amount so that the temperature of the mixture obtained in step b) is at least 0° C. higher, more preferably at least 1° C. higher, even more preferably at least 5° C. higher than the temperature of the proteins comprising vital gluten provided in step a), i.e. the temperature at the beginning of step b).

In a preferred embodiment of the present invention the humectant is mixed in step b) in an amount of at least 1 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 1 weight-% (in reference to the total weight of the mixture) and at most 14.0 weight-% (in reference to the total weight of the mixture) with the proteins comprising vital gluten. In a preferred embodiment of the present invention the humectant is mixed in step b) in an amount of at least 2.5 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 2.5 weight-% (in reference to the total weight of the mixture) and at most 14.0 weight-% (in reference to the total weight of the mixture) with the proteins comprising vital gluten. In a preferred embodiment of the present invention the humectant is mixed in step b) in an amount of at least 4 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 4 weight-% (in reference to the total weight of the mixture) and at most 14.0 weight-% (in reference to the total weight of the mixture) with the proteins comprising vital gluten. In a preferred embodiment of the present invention the humectant is mixed in step b) in an amount of at least 5 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 5 weight-% (in reference to the total weight of the mixture) and at most 14.0 weight-% (in reference to the total weight of the mixture) with the proteins comprising vital gluten. In a preferred embodiment of the present invention the humectant is mixed in step b) in an amount of at least 5.1 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 5.1 weight-% (in reference to the total weight of the mixture) and at most 14.0 weight-% (in reference to the total weight of the mixture) with the proteins comprising vital gluten. In a preferred embodiment of the present invention the humectant is mixed in step b) in an amount of at least 5.5 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 5.5 weight-% (in reference to the total weight of the mixture) and at most 14.0 weight-% (in reference to the total weight of the mixture) with the proteins comprising vital gluten. In a preferred embodiment of the present invention the humectant is mixed in step b) in an amount of at least 6 weight-% (in reference to the total weight of the mixture) and at most 14.5 weight-% (in reference to the total weight of the mixture) with the proteins comprising vital gluten. In a preferred embodiment of the present invention the humectant is mixed in step b) in an amount of at least 6 weight-% (in reference to the total weight of the mixture) and at most 14.0 weight-% (in reference to the total weight of the mixture) with the proteins comprising vital gluten. In an alternative embodiment of the present invention the humectant is mixed in step b) in an amount of at least 8 weight-% (in reference to the total weight of the mixture) and at most 14.5 weight-% (in reference to the total weight of the mixture) with the proteins comprising vital gluten. In an alternative embodiment of the present invention the humectant is mixed in step b) in an amount of at least 8 weight-% (in reference to the total weight of the mixture) and at most 14.0 weight-% (in reference to the total weight of the mixture) with the proteins comprising vital gluten. In an alternative embodiment of the present invention the humectant is mixed in step b) in an amount of at least 10 weight-% (in reference to the total weight of the mixture) and at most 14.5 weight-% (in reference to the total weight of the mixture) with the proteins comprising vital gluten. In an alternative embodiment of the present invention the humectant is mixed in step b) in an amount of at least 10 weight-% (in reference to the total weight of the mixture) and at most 14.0 weight-% (in reference to the total weight of the mixture) with the proteins comprising vital gluten.

In a preferred embodiment of the present invention the humectant is mixed in step b) in an amount of at least 1 weight-% (in reference to the total weight of the mixture) and at most 12 weight-% (in reference to the total weight of the mixture) with the proteins comprising vital gluten. In a preferred embodiment of the present invention the humectant is mixed in step b) in an amount of at least 2.5 weight-% (in reference to the total weight of the mixture) and at most 12.0 weight-% (in reference to the total weight of the mixture) with the proteins comprising vital gluten. In a preferred embodiment of the present invention the humectant is mixed in step b) in an amount of at least 5 weight-% (in reference to the total weight of the mixture) and at most 12 weight-% (in reference to the total weight of the mixture) with the proteins comprising vital gluten. In a preferred embodiment of the present invention the humectant is mixed in step b) in an amount of at least 5.1 weight-% (in reference to the total weight of the mixture) and at most 12 weight-% (in reference to the total weight of the mixture) with the proteins comprising vital gluten. In a preferred embodiment of the present invention the humectant is mixed in step b) in an amount of at least 5.5 weight-% (in reference to the total weight of the mixture) and at most 12 weight-% (in reference to the total weight of the mixture) with the proteins comprising vital gluten. In a preferred embodiment of the present invention the humectant is mixed in step b) in an amount of at least 6 weight-% (in reference to the total weight of the mixture) and at most 12 weight-% (in reference to the total weight of the mixture) with the proteins comprising vital gluten. In an alternative embodiment of the present invention the humectant is mixed in step b) in an amount of at least 8 weight-% (in reference to the total weight of the mixture) and at most 12 weight-% (in reference to the total weight of the mixture) with the proteins comprising vital gluten. In an alternative embodiment of the present invention the humectant is mixed in step b) in an amount of at least 10 weight-% (in reference to the total weight of the mixture) and at most 12 weight-% (in reference to the total weight of the mixture) with the proteins comprising vital gluten.

In a preferred embodiment of the present invention the humectant is mixed in step b) in an amount of at least 1 weight-% (in reference to the total weight of the mixture) with the proteins comprising vital gluten. In a preferred embodiment of the present invention the humectant is mixed in step b) in an amount of at least 2.5 weight-% (in reference to the total weight of the mixture) with the proteins comprising vital gluten. In a preferred embodiment of the present invention the humectant is mixed in step b) in an amount of at least 5 weight-% (in reference to the total weight of the mixture) with the proteins comprising vital gluten.

In a preferred embodiment of the present invention the humectant is mixed in step b) in an amount of more than 5 weight-% (in reference to the total weight of the mixture) with the proteins comprising vital gluten. In a preferred embodiment of the present invention the humectant is mixed in step b) in an amount of at least 5.1 weight-% (in reference to the total weight of the mixture) with the proteins comprising vital gluten. In a preferred embodiment of the present invention the humectant is mixed in step b) in an amount of at least 5.5 weight-% (in reference to the total weight of the mixture) with the proteins comprising vital gluten. In a preferred embodiment of the present invention the humectant is mixed in step b) in an amount of at least 6 weight-% (in reference to the total weight of the mixture) with the proteins comprising vital gluten. In an alternative embodiment of the present invention the humectant is mixed in step b) in an amount of at least 7 weight-% (in reference to the total weight of the mixture) with the proteins comprising vital gluten. In an alternative embodiment of the present invention the humectant is mixed in step b) in an amount of at least 8 weight-% (in reference to the total weight of the mixture) with the proteins comprising vital gluten. In an alternative embodiment of the present invention the humectant is mixed in step b) in an amount of at least 10 weight-% (in reference to the total weight of the mixture) with the proteins comprising vital gluten.

In a preferred embodiment of the present invention the humectant is mixed in step b) in an amount at most 15 weight-% (in reference to the total weight of the mixture) with the proteins comprising vital gluten. In a preferred embodiment of the present invention the humectant is mixed in step b) in an amount at most 14.5 weight-% (in reference to the total weight of the mixture) with the proteins comprising vital gluten. In a preferred embodiment of the present invention the humectant is mixed in step b) in an amount at most 14 weight-% (in reference to the total weight of the mixture) with the proteins comprising vital gluten. In a preferred embodiment of the present invention the humectant is mixed in step b) in an amount at most 13 weight-% (in reference to the total weight of the mixture) with the proteins comprising vital gluten. In a preferred embodiment of the present invention the humectant is mixed in step b) in an amount at most 12.5 weight-% (in reference to the total weight of the mixture) with the proteins comprising vital gluten. In a preferred embodiment of the present invention the humectant is mixed in step b) in an amount at most 12 weight-% (in reference to the total weight of the mixture) with the proteins comprising vital gluten. In a preferred embodiment of the present invention the humectant is mixed in step b) in an amount at most 11 weight-% (in reference to the total weight of the mixture) with the proteins comprising vital gluten. In a preferred embodiment of the present invention the humectant is mixed in step b) in an amount at most 10 weight-% (in reference to the total weight of the mixture) with the proteins comprising vital gluten. In a preferred embodiment of the present invention the humectant is mixed in step b) in an amount at most 8 weight-% (in reference to the total weight of the mixture) with the proteins comprising vital gluten.

In a preferred embodiment of the present invention the mixture of the proteins comprising vital gluten and the humectant obtained in step b) has a total moisture content of more than 12 weight-% (in reference to the total weight of the mixture).

In a preferred embodiment of the present invention the mixture of the proteins comprising vital gluten and the humectant obtained in step b) has a total moisture content of at most 16 weight-%. In a preferred embodiment of the present invention the mixture of the proteins comprising vital gluten and the humectant obtained in step b) has a total moisture content of at most 15 weight-%. In a preferred embodiment of the present invention the mixture of the proteins comprising vital gluten and the humectant obtained in step b) has a total moisture content of at most 14.5 weight-%. In a preferred embodiment of the present invention the mixture of the proteins comprising vital gluten and the humectant obtained in step b) has a total moisture content of at most 14 weight-%.

In a preferred embodiment of the present invention the mixture of the proteins comprising vital gluten and the humectant obtained in step b) has a total moisture content of more than 12 weight-% and at most 15 weight-%. In a preferred embodiment of the present invention the mixture of the proteins comprising vital gluten and the humectant obtained in step b) has a total moisture content of at least 12.1 weight-% and at most 15 weight-%. In a preferred embodiment of the present invention the mixture of the proteins comprising vital gluten and the humectant obtained in step b) has a total moisture content of at least 12.5 weight-% and at most 15 weight-%.

In a preferred embodiment of the present invention the mixture of the proteins comprising vital gluten and the humectant obtained in step b) has a total moisture content of more than 12 weight-% and at most 14.5 weight-%. In a preferred embodiment of the present invention the mixture of the proteins comprising vital gluten and the humectant obtained in step b) has a total moisture content of at least 12.1 weight-% and at most 14.5 weight-%. In a preferred embodiment of the present invention the mixture of the proteins comprising vital gluten and the humectant obtained in step b) has a total moisture content of at least 12.5 weight-% and at most 14.5 weight-%.

In a preferred embodiment of the present invention the mixture of the proteins comprising vital gluten and the humectant obtained in step b) has a total moisture content of more than 12 weight-% and at most 14.0 weight-%. In a preferred embodiment of the present invention the mixture of the proteins comprising vital gluten and the humectant obtained in step b) has a total moisture content of at least 12.1 weight-% and at most 14.0 weight-%. In a preferred embodiment of the present invention the mixture of the proteins comprising vital gluten and the humectant obtained in step b) has a total moisture content of at least 12.5 weight-% and at most 14.0 weight-%.

In a preferred embodiment of the present invention the mixture of the proteins comprising vital gluten and the humectant obtained in step b) has a total moisture content of at least 13 weight-% and at most 14.5 weight-%.

In an alternative embodiment of the present invention the mixture of the proteins comprising vital gluten and the humectant obtained in step b) has a total moisture content of at most 12 weight-%.

The total moisture content of the mixture refers to the total weight of the mixture.

In a preferred embodiment of the invention no heated air is provided in step b).

In a preferred embodiment of the present invention the temperature of the mixture is at most 60° C. during step b). In a preferred embodiment of the present invention the temperature of the mixture is at most 50° C. during step b). In a preferred embodiment of the present invention the temperature of the mixture is less than 50° C. during step b). In a preferred embodiment of the present invention the temperature of the mixture is at most 49.9° C. during step b). In a preferred embodiment of the present invention the temperature of the mixture is at most 49.5° C. during step b). In a preferred embodiment of the present invention the temperature of the mixture is at most 49° C. during step b). In a preferred embodiment of the present invention the temperature of the mixture is at most 46° C. during step b).

In a preferred embodiment of the present invention the temperature of the mixture is at least 16° C. during step b). In a preferred embodinvent of the present invention the temperature of the mixture is at least 18° C. during step b). In a preferred embodiment of the present invention the temperature of the mixture is at least 20° C. during step b). In a preferred embodiment of the present invention the temperature of the mixture is at least 22° C. during step b). In a preferred embodiment of the present invention the temperature of the mixture is at least 25° C. during step b). In a preferred embodiment of the present invention the temperature of the mixture is at least 30° C. during step b). In a preferred embodiment of the present invention the temperature of the mixture is more than 30° C. during step b). In a preferred embodiment of the present invention the temperature of the mixture is at least 31° C. during step b). In a preferred embodiment of the present invention the temperature of the mixture is at least 32° C. during step b). In a preferred embodiment of the present invention the temperature of the mixture is at least 34° C. during step b). In a preferred embodiment of the present invention the temperature of the mixture is at least 35° C. during step b).

In a preferred embodiment of the present invention the temperature of the mixture is at least 31° C. and at most 60° C. during step b). In a preferred embodiment of the present invention the temperature of the mixture is at least 34° C. and at most 60° C. during step b).

In a preferred embodiment of the present invention the temperature of the mixture is more than 30° C. and less than 50° C. during step b).

In a preferred embodiment of the present invention the temperature of the mixture is at least 31° C. and at most 49° C. during step b). In a preferred embodiment of the present invention the temperature of the mixture is at least 32° C. and at most 48° C. during step b). In a preferred embodiment of the present invention the temperature of the mixture is at least 34° C. and at most 45° C. during step b).

In a preferred embodiment of the present invention the temperature of the mixture is at most 60° C. In a preferred embodiment of the present invention the temperature of the mixture is less than 50° C.

In a preferred embodiment of the present invention the mixture has at least room temperature. In a preferred embodiment of the present invention the mixture has a temperature of at least 16° C. In a preferred embodiment of the present invention the temperature of the mixture is at least 20° C. In a preferred embodiment of the present invention the temperature of the mixture is at least 25° C. In a preferred embodiment of the present invention the temperature of the mixture is at least 30° C. In a preferred embodiment of the present invention the temperature of the mixture is more than 30° C. In a preferred embodiment of the present invention the temperature of the mixture is at least 31° C. In a preferred embodiment of the present invention the temperature of the mixture is at least 32° C. In a preferred embodiment of the present invention the temperature of the mixture is at least 34° C. In a preferred embodiment of the present invention the temperature of the mixture is at least 35° C.

In a preferred embodiment of the present invention the temperature of the mixture is at least 31° C. and at most 60° C. In a preferred embodiment of the present invention the temperature of the mixture is at least 34° C. and at most 60° C.

In a preferred embodiment of the present invention the temperature of the mixture is more than 30° C. and less than 50° C. In a preferred embodiment of the present invention the temperature of the mixture is at least 31° C. and at most 49° C. In a preferred embodiment of the present invention the temperature of the mixture is at least 32° C. and at most 48° C. In a preferred embodiment of the present invention the temperature of the mixture is at least 34° C. and at most 45° C.

Since the liquid compound of the humectant is added preferably in amounts of at most 15 weight-%, the liquid compound can be warmer than the upper limit temperature of the mixture. The liquid compound provided for step b), preferably the water or the stillage or the process condensate can have for example a temperature of at least room temperature, preferably of at least 16° C. and at most 85° C., more preferably of at most 80° C., most preferably of at most 75° C. However, in an alternative embodiment the liquid compound provided for step b) can have a temperature in the range of the temperature given for the mixture obtained in step b).

In a preferred embodiment of the present invention the temperature of the mixture is at most 60° C. at the beginning of step c). In a preferred embodiment of the present invention the temperature of the mixture is at most 55° C. at the beginning of step c). In a preferred embodiment of the present invention the temperature of the mixture is at most 50° C. at the beginning of step c). In a preferred embodiment of the present invention the temperature of the mixture is less than 50° C. at the beginning of step c). In a preferred embodiment of the present invention the temperature of the mixture is at most 49.5° C. at the beginning of step c). In a preferred embodiment of the present invention the temperature of the mixture is at most 49° C. at the beginning of step c). In a preferred embodiment of the present invention the temperature of the mixture is at most 48° C. at the beginning of step c). In a preferred embodiment of the present invention the temperature of the mixture is at most 47° C. at the beginning of step c). In a preferred embodiment of the present invention the temperature of the mixture is at most 46° C. at the beginning of step c). In a preferred embodiment of the present invention the temperature of the mixture is at most 45° C. at the beginning of step c).

In a preferred embodiment of the present invention the temperature of the mixture is at least room temperature at the beginning of step c). In a preferred embodiment of the present invention the temperature of the mixture is at least 16° C. at the beginning of step c). In a preferred embodiment of the present invention the temperature of the mixture is at least 18° C. at the beginning of step c). In a more preferred embodiment of the present invention the temperature of the mixture is at least 20° C. at the beginning of step c). In a more preferred embodiment of the present invention the temperature of the mixture is at least 22° C. at the beginning of step c).

In a preferred embodiment of the present invention the temperature of the mixture is at least 25° C. at the beginning of step c). In a preferred embodiment of the present invention the temperature of the mixture is at least 29° C. at the beginning of step c). In a preferred embodiment of the present invention the temperature of the mixture is at least 30° C. at the beginning of step c). In a preferred embodiment of the present invention the temperature of the mixture is more than 30° C. at the beginning of step c). In a preferred embodiment of the present invention the temperature of the mixture is at least 31° C. at the beginning of step c). In a preferred embodiment of the present invention the temperature of the mixture is at least 32° C. at the beginning of step c). In a preferred embodiment of the present invention the temperature of the mixture is at least 34° C. at the beginning of step c). In a preferred embodiment of the present invention the temperature of the mixture is at least 35° C. at the beginning of step c).

In a preferred embodiment of the present invention the temperature of the mixture is at least 57° C. and at most 64° C. at the beginning of step c). In a preferred embodiment of the present invention the temperature of the mixture is at least 56° C. and at most 63° C. at the beginning of step c). In a preferred embodiment of the present invention the temperature of the mixture is around 60° C. at the beginning of step c).

In a preferred embodiment of the present invention the temperature of the mixture is at least 31° C. and at most 60° C. at the beginning of step c). In a preferred embodiment of the present invention the temperature of the mixture is at least 34° C. and at most 60° C. at the beginning of step c).

In a preferred embodiment of the present invention the temperature of the mixture is more than 30° C. and less than 50° C. at the beginning of step c). In a preferred embodiment of the present invention the temperature of the mixture is at least 31° C. and at most 49° C. at the beginning of step c). In a preferred embodiment of the present invention the temperature of the mixture is at least 32° C. and at most 48° C. at the beginning of step c). In a preferred embodiment of the present invention the temperature of the mixture is at least 34° C. and at most 45° C. at the beginning of step c).

Pellets are formed in step c) from the mixture obtained in step b).

In a preferred embodiment the pellets according to the present invention and/or provided in step c) contain less than 20 weight-% starch. In a preferred embodiment the pellets according to the present invention and/or provided in step c) contain less than 15 weight-% starch. In a preferred embodiment the pellets according to the present invention and/or provided in step c) contain less than 10 weight-% starch. In a preferred embodiment the pellets according to the present invention and/or provided in step c) contain less than 5 weight-% starch. In a preferred embodiment the pellets according to the present invention and/or provided in step c) contain less than 2 weight-% starch. In a preferred embodiment the pellets according to the present invention and/or provided in step c) contain essentially no starch. In a preferred embodiment the pellets according to the present invention and/or provided in step c) contain no starch.

In a preferred embodiment the pellets according to the present invention and/or provided in step c) contain more than 75 weight-% protein (measured on the dry basis of the pellet). In a preferred embodiment the pellets according to the present invention and/or provided in step c) contain at least 76 weight-% protein (measured on the dry basis of the pellet). In a preferred embodiment the pellets according to the present invention and/or provided in step c) contain at least 77 weight-% protein (measured on the dry basis of the pellet). In a preferred embodiment the pellets according to the present invention and/or provided in step c) contain at least 78 weight-% protein (measured on the dry basis of the pellet). In a preferred embodiment the pellets according to the present invention and/or provided in step c) contain at least 79 weight-% protein (measured on the dry basis of the pellet). In a preferred embodiment the pellets according to the present invention and/or provided in step c) contain at least 80 weight-% protein (measured on the dry basis of the pellet).

In a preferred embodiment the pellets according to the present invention and/or provided in step c) contain at least 80 weight-% protein (N6.25/dry).

In a preferred embodiment the pellets according to the present invention and/or provided in step c) contain less than 1 weight-% of a shelf-stabilizing agent. In a preferred embodiment the pellets according to the present invention and/or provided in step c) contain less than 0.5 weight-% of a shelf-stabilizing agent. In a preferred embodiment the pellets according to the present invention and/or provided in step c) contain at most 0.4 weight-% of a shelf-stabilizing agent. In a preferred embodiment the pellets according to the present invention and/or provided in step c) contain at most 0.3 weight-% of a shelf-stabilizing agent. In a preferred embodiment the pellets according to the present invention and/or provided in step c) contain at most 0.2 weight-% of a shelf-stabilizing agent. The shelf-stabilizing agent is preferably at least one substance of the group consisting of hydrolysed protein, hydrolysed protein derivatives and hydrolysed protein/hydrolysed protein derivatives—emulsifier complexes.

In a preferred embodiment the pellets according to the present invention and/or provided in step c) contain less than 10 weight-% of a plasticizer. In a preferred embodiment the pellets according to the present invention and/or provided in step c) contain at most 9 weight-% of a plasticizer. In a preferred embodiment the pellets according to the present invention and/or provided in step c) contain at most 7.5 weight-% of a plasticizer. In a preferred embodiment the pellets according to the present invention and/or provided in step c) contain at most 5 weight-% of a plasticizer. In a preferred embodiment the pellets according to the present invention and/or provided in step c) contain less than 1 weight-% of a plasticizer. The plasticizer is preferably at least one substance of the group consisting of glycerol, diglycerol, propylene, glycol, triethylene glycol, urea, sorbitol, mannitol, maltitol, hydrogenated corn syrup, polyvinylalcohol, polyethylene glycol and mixtures thereof.

In a preferred embodiment the pellets according to the present invention and/or provided in step c) contain essentially no concentrated vinasse, no molasses, no corn syrup and no lignosulfonates.

In a preferred embodiment the pellets according to the present invention and/or provided in step c) contain no concentrated vinasse, no molasses, no corn syrup and no lignosulfonates.

In a preferred embodiment the pellets according to the present invention and/or provided in step c) contain no vegetable oil. In a preferred embodiment the pellets according to the present invention and/or provided in step c) contain no oil. In a preferred embodiment the pellets according to the present invention and/or provided in step c) contain essentially no vegetable oil. In a preferred embodiment the pellets according to the present invention and/or provided in step c) contain essentially no oil.

In a preferred embodiment the pellets according to the present invention and/or provided in step c) contain at least 2 weight-% fat. In a preferred embodiment the pellets according to the present invention and/or provided in step c) contain at most 10 weight-% fat.

In a preferred embodiment the pellets according to the present invention and/or provided in step c) contain at least 3 weight-% and at most 9 weight-% fat. In a preferred embodiment the pellets according to the present invention and/or provided in step c) contain at least 4 weight-% and at most 7 weight-% fat.

In a preferred embodiment the pellets according to the present invention and/or provided in step c) are not heated after step c). In a preferred embodiment the pellets according to the present invention and/or provided in step c) are not heated after step c) to a temperature of more than 80° C., more preferably of more than 75° C., more preferably more than 65° C., most preferably more than 55° C.

In a preferred embodiment the mixture is mixed in step b) not under pressure or under pressure, wherein the pressure is below 0.25 MPa, more preferably below 0.20 MPa, most preferably below 0.15 MPa.

In the context of the present invention “pellets” comprise grains, granules and other types of particles, in so far it relates to compressed material.

Accordingly the pellet formed in step c) is a compressed mixture of proteins comprising vital gluten and a humectant comprising a liquid compound.

In a preferred embodiment of the present invention the at least one pellet has a diameter of at least 1 mm. More preferably the pellet has a diameter of at least 2 mm.

In a preferred embodiment of the present invention the at least one pellet has a diameter of at least 50 mm. More preferably the pellet has a diameter of at least 20 mm.

In a preferred embodiment of the present invention the at least one pellet has a diameter of at least 3 mm and at most 9 mm. More preferably the pellet has a diameter of at least 4 mm and at most 8 mm. More preferably the pellet has a diameter of at least 6 mm and at most 9 mm. More preferably the pellet has a diameter of at least 6 mm and at most 8 mm.

A skilled person knows suitable forming methods to obtain pellets. The mixture can be poured for example through a die. The pellets can be formed for example in a press or in an extruder.

The forming of the pellet results in an increase of the temperature. Preferably the temperature of at least one pellet obtained in step c) is at most 75° C., more preferably at most 73° C.

In a preferred embodiment of the present invention the process comprises a further step d) cooling the at least one pellet obtained in step c).

In a preferred embodiment of the present invention the process comprises a further step e) feeding the at least one pellet cooled in step d) into a repository via a pneumatic transport device.

In a preferred embodiment of the present invention the process comprises a further step d)′ feeding the at least one pellet obtained in step c) into a repository via a pneumatic transport device.

In a preferred embodiment of the present invention the process comprises a further step e) feeding the at least one pellet obtained in step c) or cooled in step d) into a repository via a pneumatic transport device.

Due to according regulations, pellets that comprise vital gluten as an end product, especially if used as animal feed, shall have a moisture content of at most 12 weight-%. Therefore the state of the art concluded that during the pellet production the moisture content of the according proteins comprising gluten shall never be higher than 12 weight-%. The inventors of the present invention found that the use of a cooling step d) and the use of a feeding step e) using a pneumatic transport device reduces the moisture content of the pellets. The cooling step d) can reduce the moisture content of the pellets in an amount of up to 2 weight-%. The transport via a pneumatic device can further reduce the moisture content of the pellets up to 0.5 weight-%. Therefore, the moisture content of the pellets obtained in step c) as an intermediate product can have advantageously a moisture content of up to 14.5 weight-% if the method comprises cooling step d) and feeding step e). The pellets obtained in step c) as intermediate product can have a moisture content of at most 14 weight-% if only a cooling step d) is used without further transport via a pneumatic transport device. Therefore, steps d), d)′ and/or e) make it possible to add more humectant in step b) to the proteins comprising vital gluten than in the state of the art. The addition of more humectant than in the state of the art results in better pellets obtained in step c). On the other side, the addition of more humectant than in the state of the art is only possible due to the present invention and the according use of a liquid compound. Using only steam as humectant would result in too high temperatures if more than 5 weight-% or even more than 4 weight-% is used. These high temperatures would result in a low content of vital gluten. Accordingly, the method according to the present invention and the according use of a liquid compound in the humectant has not only the advantage that energy and costs are saved, but also that more moisture can be added in step b) than in the state of the art.

In a preferred embodiment of the present invention the process comprises a further step d) cooling the at least one pellet obtained in step c) and removing moisture from the pellet, preferably removing at most 2 weigth-% of moisture from the pellet. In a preferred embodiment of the present invention the process comprises a further step d) cooling the at least one pellet obtained in step c) and reducing the total moisture content of the pellet to at most 12 weight-%.

In a preferred embodiment of the present invention the process comprises a further step e) feeding the at least one pellet cooled in step d) into a repository via a pneumatic transport device and removing moisture from the pellet, preferably removing at most 0.5 weight-% of moisture from the pellet. In a preferred embodiment of the present invention the process comprises a further step e) feeding the at least one pellet cooled in step d) into a repository via a pneumatic transport device and reducing the total moisture content of the pellet to at most 12 weight-%.

In a preferred embodiment of the present invention the process comprises a further step d)′ feeding the at least one pellet obtained in step c) into a repository via a pneumatic transport device and removing moisture from the pellet, preferably removing at most 0.5 weight-% of moisture from the pellet. In a preferred embodiment of the present invention the process comprises a further step d)′ feeding the at least one pellet obtained in step c) into a repository via a pneumatic transport device and reducing the total moisture content of the pellet to at most 12 weight-%.

In a preferred embodiment of the invention the at least one pellet is transported in the pneumatic transport device with a pressure of at least 175 mbar. In a preferred embodiment of the invention the at least one pellet is transported in the pneumatic transport device with a pressure of at most 285 mbar. In a preferred embodiment of the invention the at least one pellet is transported in the pneumatic transport device with a pressure of at least 220 mbar. In a preferred embodiment of the invention the at least one pellet is transported in the pneumatic transport device with a pressure of at most 250 mbar. In a preferred embodiment of the invention the at least one pellet is transported in the pneumatic transport device with a pressure of at least 220 mbar and at most 250 mbar.

In a preferred embodiment of the invention the at least one pellet is transported in the pneumatic transport device with airpressure.

Accordingly, in a preferred embodiment of the invention the at least one pellet is transported in the pneumatic transport device with air. The air is preferably dried with an adsorption dehumidifier.

In a preferred embodiment of the invention the at least one pellet is transported in the pneumatic transport device with air, wherein the air has a temperature of at most 80° C., more preferably of at most 79° C., even more preferably of at most 76° C.

In a preferred embodiment of the invention the at least one pellet is transported in the pneumatic transport device with air, wherein the air has a temperature of at least 60° C., more preferably of at least 61° C.

The temperature of the air results preferably only from the compression of the air used for the pressure in the pneumatic transport device.

In a preferred embodiment of the invention the at least one pellet is transported in the pneumatic transport device, wherein the staying time of the at least one pellet in the pneumatic transport device is at most 10 seconds, more preferably at most 8 seconds, even more preferably at most 5 seconds.

In a preferred embodiment of the invention the at least one pellet is transported in the pneumatic transport device, wherein the staying time of the at least one pellet in the pneumatic transport device is at least 3 seconds and at most 4 seconds.

In a preferred embodiment of the invention the at least one pellet is transported in the pneumatic transport device, wherein the staying time of the at least one pellet in the pneumatic transport device is at least 1 second. More preferably at least 2 seconds.

In a preferred embodiment of the present invention the total moisture content of the proteins comprising gluten and/or of the mixture of the proteins comprising gluten and the humectant is measured before step c) and/or after step d).

In a preferred embodiment of the present invention the total moisture content of the proteins comprising gluten is measured before step c). The total moisture content of proteins comprising gluten can be measured for example at the beginning, at the end or during the mixing step b).

In an alternative embodiment of the present invention the total moisture content of the proteins comprising gluten and/or of the mixture of the proteins comprising gluten and the humectant is measured after step d).

The measurement of the moisture content, especially “inline” during step b) or before step c) or after step d), has the advantage that the total moisture content of the mixture is known during the process, so that as much humectant as possible can be added, for example so that the humectant can be added in an amount to obtain the mixture having a total moisture content of more than 12 weight-% and up to 14.5 weight-% or to any other wished total moisture content.

The present invention refers also to the provision of a pellet, obtainable by a process according to the present invention. The present invention refers also to the provision of a pellet, obtained by a process according to the present invention.

If stillage is used the pellet comprises preferably the dry compounds present in the stillage.

The present invention refers also to the provision of a pellet consisting essentially of compressed proteins, wherein the compressed proteins comprise gluten, wherein the gluten has a vitality of more than 70% of the vitality of glutenin.

Preferably the gluten in the pellets has a vitality of more than 71% of the vitality of glutenin. Even more preferably the gluten in the pellets has a vitality of more than 75% of the vitality of glutenin. Most preferably the gluten in the pellets has a vitality of more than 75% of the vitality of glutenin.

Preferably the vitality of the gluten in the pellets is compared to the vitality of glutenin. Pure gluten powder has normally a vitality of for example 87 to 88% if the vitality of glutenin has the reference value 100%. The vitality of the gluten decreases due to the pellet production, for example due to the heat used in the pellet production. The present invention provides a method, wherein the vitality of the gluten is reduced in only minimal amounts. Therefore, pellets can be provided in which the gluten has a higher vitality compared to the state of the art.

Preferably the vitality is a measured in an extraction method of the vital gluten with dilute acetic acid. Preferably as analytical compound glutenin is analysed to have a comparison value.

A possible method to measure the vitality of the gluten and especially of the gluten in the pellets of the present invention is described in U.S. Pat. No. 5,874,122 A, especially in column 2, line 38 to column 3, line 65.

Further guidance can be found in Commission Regulation (EC) No 152/2009 of 27 Jan. 2009 laying down the methods of sampling and analysis for the official control of feed, Annex II, paragraph C “Determination of the content of crude protein”.

According to the present invention, the vitality is measured preferably as follows:

(1) Upon determination of gluten vitality, soluble protein content is first determined. The determination of the soluble protein content is carried out as follows:

(1-1) About 2 g of a sample are precisely weighed into a 100 ml volume beaker.

(1-2) 40 ml of 0.05 N acetic acid are added to the beaker and stirred using a stirrer at room temperature for 60 min. to prepare a suspension.

(1-3) The suspension is placed into a centrifuge tube and centrifuged at 5000 rpm for 5 min. and then filtered through a filter paper to recover the filtrate.

(1-4) The beaker as used above is washed with 40 ml of 0.05 N acetic acid. The washings are placed into a centrifuge tube and centrifuged at 5000 rpm for 5 min., followed by filtration through a filter paper to recover the filtrate.

(1-5) The filtrates recovered in the above steps (1-3) and (1-4) are combined to make up to 100 ml.

(1-6) 25 ml of the liquid prepared in the above step (1-5) are replaced into a Kjeldahl tube in a Kjeltec Autosystem, preferably in the a Kjeltec Autosystem manufactured by Tecator Co., Ltd. (Sweden) using a whole pipette, and then one tablet of the decomposition-promoting agent (composed of potassium sulphate and copper sulphate at a ratio of 9:1) and 15 ml of conc. sulphuric acid are added.

(1-7) Using a Kjeltec decomposition furnace, preferably the DIGESTION SYSTEM 20 1015 type, incorporated in the above Kjeltec Autosystem, decomposition is carried out. preferably with dial 4 for one hour and then automatized with dial 9 or 10 for one hour.

(1-8) The decomposed liquid is continuously and automatically distilled and titrated. preferably using the Kjeltec Distillation and Titration System (KJELTEC AUTO 1030 type) incorporated in the same Kjeltec Autosystem. Incidentally, titration is carried out using 0.1 N sulphuric acid.

(1-9) A soluble protein content is calculated in accordance with the following equation:

$$Soluble crude protein content ( \% ) = 14 * ( T - B ) * c * N * \frac{100}{S} * 4$$

wherein:
14: molecular weight of nitrogen (g/mol)
T: amount (ml) of 0.1 N sulphuric acid required for titration,
B: amount (ml) of 0.1 N sulphuric acid required for blank titration,
c: concentration of 0.1N sulphuric acid used for titration (as determined on use or a commercially available product with titer indication may be used),
N: conversion factor for nitrogen protein. For food N=5.70. For feed
N=6.25. Preferably for the present invention N=6.25
S: weighed amount of sample (g).
4: dilution factor
100: factor for the conversion to
(2) Next, crude protein content is determined:

(2-1) About 0.5 g of a sample is precisely weighed into a Kjeldahl tube in a Kjeltec Autosystem, preferably the Kjeltec Autosystem manufactured by Tecator Co., Ltd. (Sweden), followed by the addition of one tablet of a decomposition-promoting agent (“Kafcut C5®”, trade name; product of Nisshin Seifun Co., Ltd.; composed of potassium sulphate and copper sulphate at a ratio of 9:1) and 15 ml of conc. sulphuric acid.

(2-2) Using a Kjeltec decomposition furnace, preferably the DIGESTION SYSTEM 20 1015 type, in the Kjeltec Autosystem, decomposition is carried out with dial 9 or 10 for one hour.

(2-3) The decomposed liquid is distilled and titrated using a Kjeltec Distillation and Titration system, preferably the KJELTEC AUTO 1030 type. The steps of (2-2) and (2-3) are continuously and automatically carried out. Incidentally, titration is carried out using 0.1 N sulphuric acid.

(2-4) The crude protein content is determined in accordance with the following equation:

$$Crude protein content ( \% ) = 14 * ( T - B ) * c * N * \frac{100}{S}$$

wherein:

14: molecular weight of nitrogen (g/mol)
T: amount (ml) of 0.1 N sulphuric acid required for titration,
B: amount (ml) of 0.1 N sulphuric acid required for blank titration,
c: concentration of 0.1N sulphuric acid used for titration (as determined
on use or a commercially available product with titer indication may be used),
N: conversion factor for nitrogen protein. For food N=5.70. For feed
N=6.25. Preferably for the present invention N=6.25
S: weighed amount of sample (g).
100: factor for the conversion to
(3) The gluten vitality is calculated in accordance with the following equation:

$$gluten vitality = \frac{soluble protein content}{crude protein content}$$

Of course also other suitable methods can be used to measure the vitality in comparison to the vitality of glutenin.

In a preferred embodiment of the present invention the pellet according to the present invention consists essentially of compressed proteins, wherein the compressed proteins comprise gluten and wherein the gluten has a water retention capacity of more than 140, even more preferably of more than 142, even more preferably of more than 144, most preferably of more than 145.

Preferably the water retention capacity (WRC), also called water binding capacity, is measured as follows: Wet gluten is washed by an automatic gluten washing apparatus (Glutomatic) and a centrifuge on an especially constructed sieve under standardized conditions. The weight of gluten forces through the sieve and the total weight of gluten (passed through and remaining on the sieve) are weighed. The total gluten is then dried under standardized conditions and weight. The difference between the weights of total wet gluten and total dry gluten is calculated, which gives the water bound in the wet gluten, referred to as water-binding capacity.

Preferably the water retention capacity (WRC), also called water binding capacity, is measured according to the AACC (2000) method number 38-12A using a Glutomatic automatic gluten washing apparatus.

In the following the preferred method to measure the water-binding capacity according to AACC method 38-12A (First approval Nov. 8, 2000) is described in detail:

The apparatus used is:

1. Glutomatic system, which includes:

a. Glutomatic, with kneader, attachment for washing chambers, tubing and submersible filter for solvent container, and electronics for 20-sec mixing and 5-min wash cycle for flour and 2-min wash, a stop, and then another 3-min wash for wheat meal.
b. Standard washing chambers with 88-μm polyester and 840-μm polyamide screens and screen holders. Metal chamber bottom for 840-μm screen is marked by a grooved ring.
c. Container for washing solvent, 10-liter or other size.
d. Dispenser, 0-5 ml or other range, adjustable in steps of 0.1 ml.
e. Centrifuge, operating at 6000±5 rpm and equipped with gluten index cassettes.
f. Gluten dryer, with Teflon surfaces, drying at 150° for 4 min.

2. Laboratory mill, with 0.8-mm screen or mill that gives equivalent particle size.

3. Balance, accurate to 0.01 g.

Following reagents are used:
Sodium chloride solution (2%). Dissolve 200 g NaCl (analytical grade) in 10 liter distilled water. Prepare new solution each day. Wash solution from Glutomatic should be maintained at 22±2° C. Salt solution ice cubes can be used for cooling and maintaining temperature.

### Procedure:

### Preliminary Steps:

1. Distance between kneader hook and screen is 0.7 mm and is factory set. If this distance is incorrect (test piece in accessory kit), contact manufacturer for assistance.

### 2. Preliminary Run

a. Before starting Glutomatic, add a few drops of water into hole in front of Plexiglas body of mixing head to lubricate shaft.
b. Attach washing chambers to Glutomatic. For testing flour procedure, press blue ON/OFF button (on newer instruments on/off switch is at the back of instrument) and then green START button. Check for 20-sec dough cycle (no fluid pumped) followed by 5-min wash cycle (bayonet moves up and solvent begins flowing at beginning of this cycle). For testing wheat meal procedure, press WASH button (WASH/MEAL on newer instruments) and then green START button. Check for 20-sec dough cycle followed by 2 min of washing and stopping of Glutomatic. Then press WASH button (START button on newer instruments with WASH/MEAL button), and check for 3 min more washing. Solvent flow during 5-min washing should be 250-280 ml (50-56 ml/min) with liquid temperature 22±2° C.
3. After filling empty wash liquid reservoir, run Glutomatic at least 2 min on wash cycle to fill system with wash liquid. Turn Glutomatic off and on to restart mixing-washing cycle (use RESET button on newer instruments).
4. Gluten dryer must be heated once before being used with gluten. Push START button on box and check for 4-min heat cycle.

### Gluten Washing:

### Flour:

1. Place 88-μm polyester screen in washing chamber without grooved ring. See Note 2. On top of screen, place plastic chamber wall with cylindrical insertion tool inside. Align and attach bottom to plastic chamber wall by pushing and turning clockwise. Or use assembled washing chamber from previous run. Wash from top and bottom with running water to remove any material left from previous run. If material on screen or between screen and bottom is not removed, take chamber apart and wash.
2. Add wash liquid to washing chamber to wet polyester screen. Remove excess water from screen by knocking chamber three times against cloth-covered palm of hand. Add 10±0.01 g well-mixed flour onto screen that contains film of liquid to prevent falling through of flour. Spread out sample over screen by shaking wash chamber in circular motion.
3. Add 4.8 ml wash solution from dispenser while holding chamber at about 30° angle. Direct stream of liquid against lowest side wall to prevent loss of liquid through screen. (For very weak gluten or low gluten content or for high gluten content, liquid content may be reduced to 4.2 ml or increased to 5.2 ml, respectively.) Shake chamber gently in circular motion to spread liquid over total top surface of sample.
4. Assemble washing chamber onto Glutomatic and press green START button for automatic 20-sec dough mixing and 5-min gluten washing. Wash liquid flow rate should immediately be 50-56 ml/min. See Notes 3 and 4. Watch for up and down movement of both chambers during kneading of gluten by hook.
5. At the end of wash cycle, lower chamber and remove gluten from chamber and kneading hook without tearing for placing in centrifuge. If gluten is torn apart into two or more pieces, test should be repeated.
6. Proceed to instructions for wet gluten and gluten index.

### Meal:

1. Follow steps 1-3 above for flour. Assemble washing chamber onto Glutomatic and then press WASH button (WASH/MEAL on newer instruments) before pressing green START button. A 20-sec dough mixing cycle will be followed by a 2-min washing (see Note 3) and stopping of Glutomatic.
2. Remove wash chamber and transfer loose material from hook into chamber. By means of plastic coupler, attach coarse sieve chamber that is assembled with 840-μm screen and metal bottom having grooved ring. Hold wash chamber upside down and wash complete contents of chamber into coarse sieve chamber with a slow stream of tap water. Rinse tap water from surface of gluten and screen with 10-15 ml of wash solvent.
3. Place coarse sieve chamber with gluten on Glutomatic and press WASH button (START button on newer instruments) for last 3 min of washing. See Note 4. Watch for up and down movement of both chambers during kneading of gluten by hook.
4. At end of wash cycle, lower chamber and remove gluten from chamber and hook without tearing for placing in centrifuge. If gluten tears into two or more pieces, test should be repeated.

### Wet Gluten Content and Gluten Index:

1. Place wet gluten from each washing chamber into a separate gluten index cassette in centrifuge. For gluten from only one wash chamber, use a counterbalance in the other gluten index cassette.
2. Start centrifuge 30 sec after end of washing cycle by pushing green START button for automatic centrifuging at 6000±5 rpm for 1 min.
3. Remove gluten index cassette from centrifuge. With spatula, remove gluten that has passed through sieve as described in manual. Weigh gluten to nearest 0.01 g. Leave gluten on balance.
4. With tweezers remove gluten remaining on top of sieve, add to gluten on balance, and weigh as total wet gluten.
5. The first test of day may give erratic result. For that reason, result should be discarded and test repeated.

### Dry Gluten Content and Water Binding in Wet Gluten:

1. Take total amount of wet gluten and place in center of lower heating surface of dryer.
2. Close dryer, and start drying at 150° C. for 4 min by pushing button on Glutimer box.
3. With tweezers, carefully remove dry gluten from the dryer. Weigh dry gluten to nearest 0.01 g.

### Cleaning and Rinsing:

After final run of day, salt should be removed by flushing and rinsing Glutomatic with distilled water. Salt should also be removed from inside of centrifuge and from centrifuge cassettes. Chamber screens should be washed with warm water.

### Calculations:

Calculate total wet gluten, gluten index, dry gluten, and water binding in wet gluten as follows:

$$\begin{matrix}\begin{matrix}\begin{matrix}\begin{matrix}\begin{matrix}\begin{matrix}\begin{matrix} Wet gluten content , \\ \% ( 14 \% moisture basis ) = \frac{total wet gluten ( g ) \times 860}{100 \text{-} \% sample moisture}\end{matrix} \\ Gluten index = \frac{wet gluten remaining on sieve ( g ) \times 100}{total wet gluten ( g )}\end{matrix} \\ Dry gluten content ,\end{matrix} \\ \% ( 14 \% moisture basis ) = \frac{total dry gluten ( g ) \times 860}{100 \text{-} \% sample moisture}\end{matrix} \\ Water binding capacity ,\end{matrix} \\ \% = wet gluten content , \% \text{-} dry gluten content , \%\end{matrix} \\ Water binding capacity = water bound in wet gluten\end{matrix}$$

Reference for suitable measurement of WRC can be found in Perten, H. 1990. “Rapid measurement of wet gluten quality by the gluten index.” Cereal Foods World 35:401.

Of course also other suitable methods can be used to measure the WRC of the gluten in the pellets.

In a preferred embodiment of the present invention, the pellet according to the present invention consists to at least 90 weight-%, more preferably to at least 95 weight-%, most preferably to at least 98 weight-% of protein.

In a preferred embodiment of the present invention the pellet according to the present invention consists essentially of protein. In a preferred embodiment of the present invention the pellet according to the present invention consists of protein.

In a preferred embodiment of the present invention the pellet according to the present invention consists to at least 90 weight-%, more preferably to at least 95 weight-%, most preferably to at least 98 weight-% of gluten.

In a preferred embodiment of the present invention the pellet according to the present invention consists essentially of gluten. In a preferred embodiment of the present invention the pellet according to the present invention consists of gluten.

Preferably the gluten in the pellets is wheat gluten or corn gluten, most preferably the gluten is wheat gluten.

In a preferred embodiment of the present invention the pellet according to the present invention consists essentially of wheat gluten. In a preferred embodiment of the present invention the pellet according to the present invention consists of wheat gluten.

In a preferred embodiment of the present invention the pellet according to the present invention is used as animal feed.

In a preferred embodiment of the present invention the pellet according to the present invention comprising gluten, wherein the gluten has a vitality of more than 70 weight-% of pure soluble gluten, is obtainable, preferably is obtained, in a process according to the present invention.

The present invention solves the underlying technical problem also by the provision of an apparatus for producing pellets of proteins comprising gluten, the apparatus comprising at least one first repository for proteins comprising gluten, the repository having at least one outlet for discharge of the proteins comprising gluten, at least one second repository for a liquid humectant, for example an aqueous system like water, stillage or process condensate, the repository having at least one outlet for discharge of the liquid humectant, at least one mixing device for mixing the proteins comprising gluten and the liquid humectant, said mixing device having at least one inlet connected to the outlets of the first and the second repositories and having at least one outlet for discharge of the mixture of the proteins comprising gluten and the liquid humectant, at least one pellet forming device for forming pellets from the mixture of the proteins comprising gluten and the liquid humectant, said pellet forming device having at least one inlet connected to the at least one outlet of the mixing device and having at least one outlet for discharge of the formed pellets, wherein the apparatus comprises at least one device for measuring the total moisture content of the proteins comprising gluten and/or of the mixture of the proteins comprising gluten and the liquid humectant and/or of the pellets formed from the mixture of the proteins comprising gluten and the liquid humectant.

In a preferred embodiment of the present invention the at least one device for measuring the total moisture content of the proteins comprising gluten and/or of the mixture of the proteins comprising gluten and the liquid humectant is assigned to at least one of the devices upstream the pellet forming device.

In a preferred embodiment of the present invention the at least one device for measuring the total moisture content of the proteins comprising gluten is assigned to the outlet of the first repository and/or to the inlet of the mixing device and/or to the connection of the outlet of the first repository and the inlet of the mixing device.

In a preferred embodiment of the present invention the at least one device for measuring the total moisture content of the mixture of the proteins comprising gluten and the liquid humectant is assigned to the mixing device and/or to the outlet of the mixing device and/or to the inlet of the pellet forming device and/or to the connection of the outlet of the mixing device and the inlet of the pellet forming device.

In a preferred embodiment of the present invention the at least one device for measuring the total moisture content of the pellets formed from the mixture of the proteins comprising gluten and the liquid humectant is assigned to the pellet forming device and/or to the outlet of the pellet forming device.

In a preferred embodiment of the present invention the apparatus according to the present invention comprises further at least one cooling device for cooling the formed pellets, said cooling device having at least one inlet connected to the at least one outlet of the pellet forming device and having at least one outlet for discharge of the cooled pellets.

In a preferred embodiment of the present invention the apparatus according to the present invention comprises further at least one pneumatic transport device for transporting the formed pellets, said pneumatic transport device having at least one inlet connected to the at least one outlet of the pellet forming device and/or connected to the at least one outlet of the cooling device and having at least one outlet for discharge of the pellets.

In a preferred embodiment of the present invention the pellet forming device is a press or an extruder.

In a preferred embodiment of the present invention the at least one device for measuring the total moisture content of the proteins comprising gluten and/or of the mixture of the proteins comprising gluten and the liquid humectant regulates the amount of the liquid humectant discharged from the outlet of the second repository.

The measurement of the total moisture content, especially “inline”, i.e with at least one device for measuring the total moisture content of the proteins comprising gluten and/or of the mixture of the proteins comprising gluten and the liquid humectant being assigned to at least one of the devices upstream the pellet forming device or downstream the pellet forming device, has the advantage that the total moisture content of the mixture is known during the process, so that as much humectant as possible can be added, for example so that the humectant can be added in an amount to obtain the mixture having a total moisture content of more than 12 weight-% and up to 14.5 weight-% or to any other wished total moisture content.

Furthermore the devices in the apparatus of the present invention are preferably connected in a way so that no thermal bridges or as few thermal bridges as possible are present in the device. This can result in even better pellets.

The present invention refers also to the use of an apparatus according to the present invention in a process for the preparing a pellet of compressed proteins comprising vital gluten. The present invention refers also to the use of an apparatus according to the present invention in a process according to the present invention.

The present invention refers also to the provision of a pellet, producible, preferably produced in an apparatus according to the present invention.

The present invention refers of course also to al plurality of pellets according to the present invention.

The present invention also refers preferably to following aspects:

Aspect 1: A process for preparing at least one pellet of compressed proteins comprising vital gluten, the process comprising following steps:

a) providing proteins comprising vital gluten,
b) mixing the proteins comprising vital gluten with an humectant, wherein the humectant comprises a liquid compound to form a mixture,
c) forming at least one pellet from the mixture of the proteins comprising vital gluten and the humectant, and
d) feeding the at least one pellet obtained in step c) into a repository via a pneumatic transport device.

Aspect 2: A process for preparing at least one pellet of compressed proteins comprising vital gluten, the process comprising following steps:

a) providing proteins comprising vital gluten,
b) mixing the proteins comprising vital gluten with an humectant, wherein the humectant consists of an liquid compound to form a mixture, wherein the liquid compound has a total content of solid matter of at most 15 weight-%, wherein the temperature of the mixture is at least 34° C. and at most 45° C.,
c) forming at least one pellet from the mixture of the proteins comprising vital gluten and the humectant.

Aspect 3: A process for preparing at least one pellet of compressed proteins comprising vital gluten, the process comprising following steps:

a) providing proteins comprising vital gluten,
b) mixing the proteins comprising vital gluten with an humectant, wherein the humectant consists of an liquid compound to form a mixture, wherein the liquid compound has a total content of solid matter of at most 15 weight-%, wherein the temperature of the mixture is at least 34° C. and at most 45° C.,
c) forming at least one pellet from the mixture of the proteins comprising vital gluten and the humectant,
d) feeding the at least one pellet obtained in step c) into a repository via a pneumatic transport device.

Aspect 4: The process according to aspect 1 or to aspect 2, wherein the humectant comprises liquid water and/or stillage and/or process condensate.

Aspect 5: The process according to anyone of the preceding aspects, wherein the humectant has a content of solid matter of at most 15 weight-%.

Aspect 6: The process according to anyone of the preceding aspects, wherein the temperature of the mixture is less than 50° C.

Aspect 7: The process according to anyone of the preceding aspects, wherein the humectant is mixed in step b) in an amount of more than 5 weight-% with the proteins comprising vital gluten.

Aspect 8: The process according to anyone of the preceding aspects, wherein the mixture of the proteins comprising vital gluten and the humectant obtained in step b) has a total moisture content of more than 12 weight-%.

Aspect 9: The process according to anyone of the preceding aspects, wherein the total moisture content of the proteins comprising gluten and/or of the mixture of the proteins comprising gluten and the humectant is measured before step c) and/or after step d).

Aspect 10: A pellet, obtainable by a process according to anyone of the preceding aspects, wherein the compressed proteins comprise gluten, wherein the gluten has a vitality of more than 70% of glutenin.

Aspect 11: The pellet according to aspect 10, consisting essentially of wheat gluten.

Aspect 12: A pellet according to aspect 10 or according to aspect 11, being produced in a method according to anyone of aspects 1 to 9.

Aspect 13: An apparatus for producing pellets of proteins comprising gluten, the apparatus comprising:
at least one first repository for proteins comprising gluten, the repository having at least one outlet for discharge of the proteins comprising gluten,
at least one second repository for a liquid humectant, the repository having at least one outlet for discharge of the liquid humectant,
at least one mixing device for mixing the proteins comprising gluten and the liquid humectant, said mixing device having at least one inlet connected to the outlets of the first and the second repositories and having at least one outlet for discharge of the mixture of the proteins comprising gluten and the liquid humectant,
at least one pellet forming device for forming pellets from the mixture of the proteins comprising gluten and the liquid humectant, said pellet forming device having at least one inlet connected to the at least one outlet of the mixing device and having at least one outlet for discharge of the formed pellets,
at least one pneumatic transport device for transporting the formed pellets, said pneumatic transport device having at least one inlet connected to the at least one outlet of the pellet forming device and having at least one outlet for discharge of the pellets,
   wherein the apparatus comprises at least one device for measuring the total moisture content of the proteins comprising gluten and/or of the mixture of the proteins comprising gluten and the liquid humectant and/or of the pellets formed from the mixture of the proteins comprising gluten and the liquid humectant.

Aspect 14: An apparatus for producing pellets of proteins comprising gluten, the apparatus comprising:
at least one first repository for proteins comprising gluten, the repository having at least one outlet for discharge of the proteins comprising gluten,
at least one second repository for a liquid humectant, the repository having at least one outlet for discharge of the liquid humectant,
at least one mixing device for mixing the proteins comprising gluten and the liquid humectant, said mixing device having at least one inlet connected to the outlets of the first and the second repositories and having at least one outlet for discharge of the mixture of the proteins comprising gluten and the liquid humectant,
at least one pellet forming device for forming pellets from the mixture of the proteins comprising gluten and the liquid humectant, said pellet forming device having at least one inlet connected to the at least one outlet of the mixing device and having at least one outlet for discharge of the formed pellets,
at least one cooling device for cooling the formed pellets, said cooling device having at least one inlet connected to the at least one outlet of the pellet forming device and having at least one outlet for discharge of the cooled pellets,
at least one pneumatic transport device for transporting the formed pellets, said pneumatic transport device having at least one inlet connected to the at least one outlet of the cooling device and having at least one outlet for discharge of the pellets,
   wherein the apparatus comprises at least one device for measuring the total moisture content of the proteins comprising gluten and/or of the mixture of the proteins comprising gluten and the liquid humectant and/or of the pellets formed from the mixture of the proteins comprising gluten and the liquid humectant.

Aspect 15: An apparatus according to aspect 13 or aspect 14, wherein the at least one device for measuring the total moisture content of the proteins comprising gluten and/or of the mixture of the proteins comprising gluten and the liquid humectant is assigned to at least one of the devices upstream the pellet forming device.

Aspect 16: An apparatus according to anyone of aspects 13 to 15, wherein the at least one device for measuring the total moisture content of the proteins comprising gluten and/or of the mixture of the proteins comprising gluten and the liquid humectant regulates the amount of the liquid humectant discharged from the outlet of the second repository.

Aspect 17: Use of an apparatus according to anyone of aspects 13 to 16 in a process according to anyone of aspects 1 to 10.

Further preferred embodiments of the aspects are the subject-matter of the present description.

Further preferred embodiments of the present invention are the subject-matter of the subclaims.

The invention will be described in more detail by way of the nonlimiting examples.

### EXAMPLES

Pellets were produced from gluten meal by addition of a humectant and by pressing the resulting mixture through dies of a press.

### 1. Gluten Meal:

As educt a gluten meal was used having a specific surface of 2328.0 cm²/cm³ and having following particle size distribution:

### D₂₀: 15,5699 μm

### D₅₀: 54,2600 μm

### D₉₀: 248,1284 μm

### 2. Humectants:

Different humectants were used:
a) thin stillage (according to the present invention)
b) thin stillage and steam (according to the present invention)
c) water and steam (according to the present invention)
d) steam (comparison according to the state of the art)

### 3. Pellet Production:

The gluten meal was mixed with the humectant in a mixer at a specific temperature. The mixture was pressed into pellets using a pellet mill equipped with a 6*50 mm mold die holes of 6 mm diameter and 15 mm length or a 8*90 mm mold die holes of 8 mm and 90 mm length. The pellets were sieved and cooled to room temperature.

### 4. Vitality and WRC of Gluten:

The vitality of the gluten was measured by extraction of the vital gluten with dilute acetic acid as outlined in the present description, above as preferred measurement procedure.

The water retention capacity (WRC) was measured according to the AACC method 38-12A (first approval Nov. 8, 2000) as outlined in the present description, above.

### 5. Pellet Quality:

The pellet quality was measured according to Holmen (1 min./450 mbar). The pellet durability index (PDI) procedure was as follows:
a) sifting of the pellets with a 3.5 mm sieve,
b) Holmen test with a 100 g sample for 60 seconds under the standard adjusted pressure of 450 mbar,
c) sifting the pellets with a 3.5 mm sieve,
d) remaining pellet weight-PDI

### 6. Results:

The results concerning vitality and water retention capacity are shown in table 1:

TABLE 1
Vitality and retention capacity of gluten pellets produced with different humectants
and temperatures. Examples No. 1 to 3 are according to the invention.
example No. 4 is according to the state of the art. The educt had a vitality of 87-88
% of original (glutenin)

| | | | | Temperature | | | |
|---|---|---|---|---|---|---|---|
| | | | Steam added | of the mixture | | | |
| | | | to a temperature | before pellet | Vitality | | |
| No. | Water | Stillage | of | forming | (%) of original | WCR | PDI |
| 1 | — | 6 wt-% | — | 36° C. | 76.9-77.3 | 150.4 | 90.2 |
| 2 | — | 6 wt-% | 50° C. | 50° C. | 75.2-75.8 | 148.3 | 95.2 |
| 3 | 2 wt-% | — | 60° C. | 60° C. | 76.1-76.5 | 144.1 | 95.5 |
| 4 | — | — | 70° C. | 70° C. | 64.1-64.5 | 137.9 | 98.2 |

### 7. Conclusions:

The pellets being produced in a method according to the present invention contain gluten with higher vitality and with a higher water retention capacity than pellets produced according to the state of the art.

Pellets produced with high temperatures in the mixer due to steam injection tend to have a more brownish colour which is probably a Maillard reaction. Pellets produced according to the present invention appear in the colour which is similar to the raw gluten meal.

The pellet durability index (PDI) is for the pellets produced according to the present invention in the same range (85% to 97%) as for the pellets produced according to the state of the art (85% to 97%).

The moisture of the pellets after cooling is below 12 weight-%. Therefore the pellets are usable as animal feed.

It can be concluded that the reliability and stability of the production process is better and the vitality of the gluten remains higher, when operating the pelleting process at a lower temperature since hot gluten tends to stick.

1. A process for preparing at least one pellet of compressed proteins comprising vital gluten, the process comprising following steps:
a) providing proteins comprising vital gluten,
b) mixing the proteins comprising vital gluten with an humectant, wherein the humectant comprises a liquid compound to form a mixture,
c) forming at least one pellet from the mixture of the proteins comprising vital gluten and the humectant, and
d) feeding the at least one pellet obtained in step c) into a repository via a pneumatic transport device.

2. The process according to claim 1, wherein the humectant comprises liquid water and/or stillage and/or process condensate.

3. The process according to claim 1, wherein the humectant has a content of solid matter of at most 15 weight-%.

4. The process according to claim 1, wherein the temperature of the mixture is less than 50° C.

5. The process according to claim 1, wherein the humectant is mixed in step b) in an amount of more than 5 weight-% with the proteins comprising vital gluten.

6. The process according to claim 1, wherein the mixture of the proteins comprising vital gluten and the humectant obtained in step b) has a total moisture content of more than 12 weight-%.

7. The process according to claim 1, wherein the total moisture content of the proteins comprising gluten and/or of the mixture of the proteins comprising gluten and the humectant is measured before step c) and/or after step d).

8. A pellet, obtainable by a process according to claim 1, wherein the compressed proteins comprise gluten, wherein the gluten has a vitality of more than 70% of glutenin.

9. The pellet according to claim 8, consisting essentially of wheat gluten.

10. (canceled)

11. An apparatus for producing pellets of proteins comprising gluten, the apparatus comprising:
at least one first repository for proteins comprising gluten, the repository having at least one outlet for discharge of the proteins comprising gluten,
at least one second repository for a liquid humectant, the repository having at least one outlet for discharge of the liquid humectant,
at least one mixing device for mixing the proteins comprising gluten and the liquid humectant, said mixing device having at least one inlet connected to the outlets of the first and the second repositories and having at least one outlet for discharge of the mixture of the proteins comprising gluten and the liquid humectant,
at least one pellet forming device for forming pellets from the mixture of the proteins comprising gluten and the liquid humectant, said pellet forming device having at least one inlet connected to the at least one outlet of the mixing device and having at least one outlet for discharge of the formed pellets,
at least one pneumatic transport device for transporting the formed pellets, said pneumatic transport device having at least one inlet connected to the at least one outlet of the pellet forming device and having at least one outlet for discharge of the pellets,
wherein the apparatus comprises at least one device for measuring the total moisture content of the proteins comprising gluten and/or of the mixture of the proteins comprising gluten and the liquid humectant and/or of the pellets formed from the mixture of the proteins comprising gluten and the liquid humectant.

12. An apparatus for producing pellets of proteins comprising gluten, the apparatus comprising:
at least one first repository for proteins comprising gluten, the repository having at least one outlet for discharge of the proteins comprising gluten,
at least one second repository for a liquid humectant, the repository having at least one outlet for discharge of the liquid humectant,
at least one mixing device for mixing the proteins comprising gluten and the liquid humectant, said mixing device having at least one inlet connected to the outlets of the first and the second repositories and having at least one outlet for discharge of the mixture of the proteins comprising gluten and the liquid humectant,
at least one pellet forming device for forming pellets from the mixture of the proteins comprising gluten and the liquid humectant, said pellet forming device having at least one inlet connected to the at least one outlet of the mixing device and having at least one outlet for discharge of the formed pellets,
at least one cooling device for cooling the formed pellets, said cooling device having at least one inlet connected to the at least one outlet of the pellet forming device and having at least one outlet for discharge of the cooled pellets,
at least one pneumatic transport device for transporting the formed pellets, said pneumatic transport device having at least one inlet connected to the at least one outlet of the cooling device and having at least one outlet for discharge of the pellets,
wherein the apparatus comprises at least one device for measuring the total moisture content of the proteins comprising gluten and/or of the mixture of the proteins comprising gluten and the liquid humectant and/or of the pellets formed from the mixture of the proteins comprising gluten and the liquid humectant.

13. An apparatus according to claim 11, wherein the at least one device for measuring the total moisture content of the proteins comprising gluten and/or of the mixture of the proteins comprising gluten and the liquid humectant is assigned to at least one of the devices upstream the pellet forming device.

14. An apparatus according to claim 11, wherein the at least one device for measuring the total moisture content of the proteins comprising gluten and/or of the mixture of the proteins comprising gluten and the liquid humectant regulates the amount of the liquid humectant discharged from the outlet of the second repository.

15. (canceled)
